(19) United States
(12) Patent Application Publication
(10) Pub. No.: US 2019/0034995 A1
(43) Pub. Date: Jan. 31, 2019

(54) INTELLIGENT SHOPPING GUIDE METHOD AND INTELLIGENT SHOPPING GUIDE DEVICE

(71) Applicant: BOE TECHNOLOGY GROUP CO., LTD., Beijing (CN)

(72) Inventor: Wenchu DONG, Beijing (CN)

(21) Appl. No.: 15/941,222

(22) Filed: Mar. 30, 2018

(30) Foreign Application Priority Data
Jul. 31, 2017 (CN) 201710644090.1

(51) Int. Cl. G06Q 30/06; G06Q 30/02

(52) U.S. Cl. CPC G06Q 30/0631; G06Q 30/0643; G06Q 30/0281

(57) ABSTRACT

An intelligent shopping guide method and an intelligent shopping guide device are disclosed, which are used for providing more intelligent and personalized purchase suggestions. The intelligent shopping guide method includes the following steps: acquiring customer data of a current customer, extracting customer characteristics from the customer data, and determining a customer category to which the current customer belongs according to the extracted customer characteristics and a number of preset customer categories; according to the customer category to which the current customer belongs and a number of preset commodity types, determining a commodity type suitable for the current customer, and recommending a commodity corresponding to the commodity type suitable for the current customer to the current customer.

### RELATED APPLICATION

This application claims priority to Chinese patent application number 201710644090.1 filed on Jul. 31, 2017, the entire content of which is incorporated herein by reference.

### FIELD OF THE DISCLOSURE

The present disclosure relates to the technical field of internet and mobile internet applications, and particularly to an intelligent shopping guide method and an intelligent shopping guide device.

### BACKGROUND OF THE DISCLOSURE

With the improvement of modern life demand for intelligent automation services, in some service places, such as shopping malls or supermarkets, intelligent aiding machines and devices come into being. At present, shopping robots in shopping malls or supermarkets have emerged, which can realize the shopping mall area route display, cruise guidance, simple voice dialogue functions.

At present, consumers put forward higher requirements on robots according to different needs, not only require them to provide simple route display and simple commodity presentation, but also require them to provide more intelligent and personalized service experience.

### SUMMARY OF THE DISCLOSURE

In view of the above, the embodiment of the present disclosure provides an intelligent shopping guide method and an intelligent shopping guide device for providing more intelligent and personalized purchase suggestions.

An embodiment of the present disclosure provides an intelligent shopping guide method, which comprises the following steps:

acquiring customer data of a current customer; extracting customer characteristics from the customer data; and determining a customer category to which the current customer belongs according to the extracted customer characteristics and a plurality of preset customer categories; according to the customer category to which the current customer belongs and a plurality of preset commodity types, determining a commodity type suitable for the current customer; and recommending a commodity corresponding to the commodity type suitable for the current customer to the current customer.

The intelligent shopping guide method provided by the embodiment of the disclosure comprises the following steps: firstly, acquiring customer data of the current customer; extracting customer characteristics corresponding to the customer data; and determining a customer category to which the current customer belongs according to the extracted customer characteristics and a plurality of preset customer categories; then, according to the customer category to which the current customer belongs and a plurality of preset commodity types, determining a commodity type suitable for the current customer; and recommending a commodity corresponding to the commodity type suitable for the current customer to the current customer. Therefore, the intelligent shopping guide method provided by the specific embodiment of the present disclosure can provide more intelligent and personalized purchase suggestions for customers.

According to an aspect of the present disclosure, determining a commodity type suitable for the current customer according to the customer category to which the current customer belongs and a plurality of preset commodity types comprises:

matching the commodity types with the customer categories one by one, and deriving a commodity corresponding to the commodity type suitable for the current customer according to the matching result and the customer category to which the current customer belongs.

According to an aspect of the present disclosure, matching the commodity types with the customer categories one by one comprises:

matching the commodity types with the customer categories one by one using a k-nearest neighbor algorithm.

According to an aspect of the present disclosure, determining a commodity type suitable for the current customer according to the customer category to which the current customer belongs and a plurality of preset commodity types comprises:

matching the customer category to which the current customer belongs with the commodity type using a k-nearest neighbor algorithm and determining a commodity type suitable for the current customer.

According to an aspect of the present disclosure, when the commodity type is an apparel type, the method further comprises: acquiring an image data of the current customer and retrieving an image data of a apparel recommended to the current customer, synthesizing the image data of the current customer and the image data of the apparel by adopting an image processing method, and generating a try-on view of the current customer trying on the apparel.

According to an aspect of the present disclosure, determining a customer category to which the current customer belongs according to the extracted customer characteristics and a plurality of preset customer categories comprises:

according to the extracted customer characteristics and a plurality of preset customer categories, determining a customer category to which the current customer belongs using a k-nearest neighbor algorithm.

According to an aspect of the present disclosure, after determining a commodity type suitable for the current customer, the method further comprises: forming a shopping route map to a shop location to which the commodity type suitable for the current customer belongs and providing the shopping route map to the current customer.

An embodiment of the disclosure also provides an intelligent shopping guide device, which comprise:

an input circuit for acquiring a customer data of a current customer;

a memory for storing a plurality of customer data in advance and storing a plurality of commodity data in advance;

a modeling circuit configured to extract customer characteristics each corresponding to each customer data from a plurality of customer data stored in the memory, and cluster the extracted customer characteristics to obtain a plurality of customer categories; and extract commodity characteristics corresponding to the customer characteristics from a plurality of commodity data stored in the memory, and cluster the extracted commodity characteristics to obtain a plurality of commodity types;

a model matching circuit configured to extract customer characteristics from the customer data, and determine a customer category to which the current customer belongs according to the extracted customer characteristics and the customer categories obtained by the modeling circuit; and determine a commodity type suitable for the current customer according to the customer category to which the current customer belongs and the commodity types obtained by the modeling circuit;

an output circuit for recommending a commodity corresponding to the commodity type suitable for the current customer determined by the model matching circuit to the current customer.

According to an aspect of the present disclosure, the model matching circuit is specifically configured to match the commodity types with the customer categories one by one using a k-nearest neighbor algorithm and derive a commodity type suitable for the current customer according to the matching result and the customer category to which the current customer belongs.

According to an aspect of the present disclosure, the model matching circuit is specifically configured to match the customer category to which the current customer belongs with the commodity types using a k-nearest neighbor algorithm and determine a commodity type suitable for the current customer.

According to an aspect of the present disclosure, when the commodity type is an apparel type, the input circuit is further configured to acquire image data of the current customer;

the model matching circuit is further configured to: retrieve an image data of an apparel recommended to the current customer, synthesize the image data of the current customer and the image data of the apparel using an image processing method, and generate a try-on view of the current customer trying on the apparel;

the output circuit is further configured to provide a try-on view of the current customer trying on the apparel to the current customer.

According to an aspect of the present disclosure, the model matching circuit is specifically configured to determine a customer category to which the current customer belongs using a k-nearest neighbor algorithm based on the extracted customer characteristics and the customer categories obtained by the modeling circuit.

According to an aspect of the present disclosure, the model matching circuit is further configured to: form a shopping route map to a shop location to which the commodity type suitable for the current customer belongs after the commodity type suitable for the current customer is determined;

the output circuit is further configured to provide the shopping route map to the current customer.

According to an aspect of the present disclosure, the output circuit is further configured to print the shopping route map and the try-on view of the current customer trying on the apparel.

### BRIEF DESCRIPTION OF THE DRAWINGS

FIG. 1 is a flowchart of an intelligent shopping guide method provided by an embodiment of the present disclosure;

FIG. 2 is a schematic diagram for implementing an intelligent shopping guide method provided by an embodiment of the disclosure;

FIG. 3 is a schematic diagram of another intelligent shopping guide method provided by an embodiment of the present disclosure;

FIG. 4 is a block diagram of an intelligent shopping guide device provided by an embodiment of the disclosure;

FIG. 5 is a schematic structural diagram of an intelligent shopping guide device provided by an embodiment of the disclosure;

FIG. 6 is a schematic diagram for implementing an intelligent shopping guide device provided by the embodiment of the disclosure.

### DETAILED DESCRIPTION OF THE DISCLOSURE

The embodiment of the disclosure provides an intelligent shopping guide method and an intelligent shopping guide device, which are used for providing more intelligent and personalized purchase suggestions.

To make the objects, technical solutions and advantages of the present disclosure clearer, the present disclosure will be described in further detail below with reference to the accompanying drawings, and it is obvious that the described embodiments are only part of the embodiments of the present disclosure, and not all the embodiments. Based on the embodiments of the present disclosure, all other embodiments obtained by one of ordinary skill in the art without creative effort are within the scope of the present disclosure.

The intelligent shopping guide method provided by the specific embodiment of the present disclosure is described in detail below with reference to the accompany drawings.

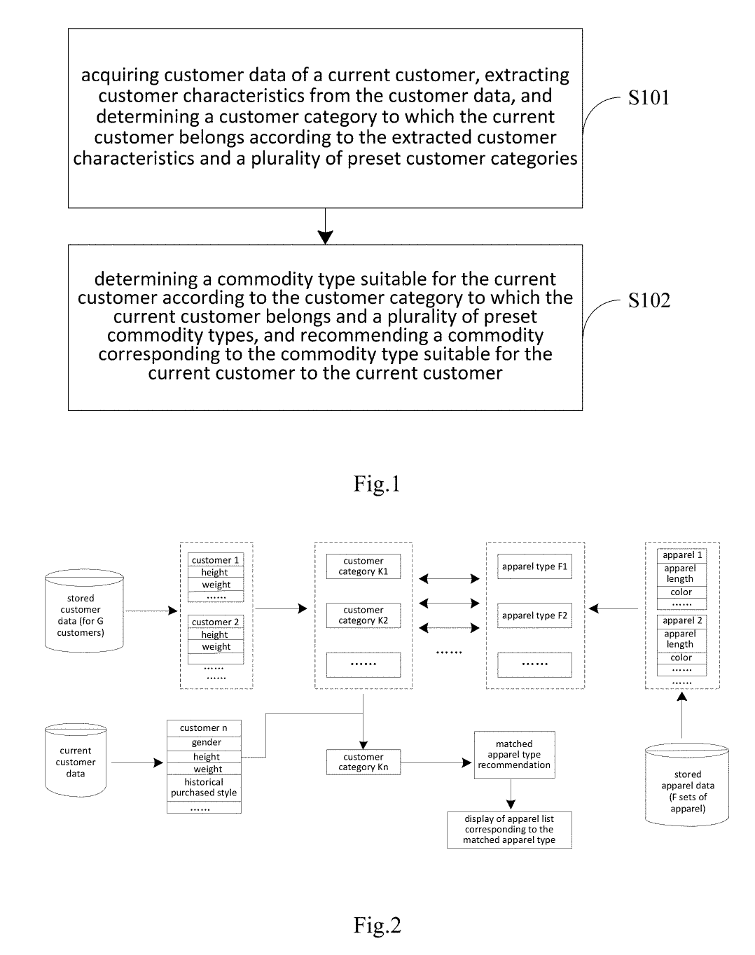

As shown in FIG. 1, a specific embodiment of the present disclosure provides an intelligent shopping guide method comprising:

S101, acquiring customer data of a current customer, extracting customer characteristics from the customer data, and determining a customer category to which the current customer belongs according to the extracted customer characteristics and a plurality of preset customer categories;

S102, determining a commodity type suitable for the current customer according to the customer category to which the current customer belongs and a plurality of preset commodity types, and recommending a commodity corresponding to the commodity type suitable for the current customer to the current customer.

In a specific embodiment of the disclosure, the customer categories are categories obtained by extracting customer characteristics each corresponding to each customer data from a plurality of customer data stored in advance and clustering the extracted customer characteristics; the commodity types are types obtained by extracting commodity characteristics corresponding to the customer characteristics from a plurality of commodity data stored in advance and clustering the extracted commodity characteristics.

The intelligent shopping guide method provided by the specific embodiment of the disclosure comprises the following steps: firstly, acquiring customer data of a current customer, extracting customer characteristics corresponding to the customer data, and determining a customer category to which the current customer belongs according to the extracted customer characteristics and a plurality of preset customer categories; then, according to the customer category to which the current customer belongs and a plurality of preset commodity types, determining a commodity type suitable for the current customer, and recommending a commodity corresponding to the commodity type suitable for the current customer to the current customer;

therefore, the intelligent shopping guide method provided by the specific embodiment of the present disclosure can provide more intelligent and personalized purchase suggestions for customers.

The intelligent shopping guide method provided by the specific embodiment of the present disclosure will be described in detail below with reference to the specific embodiment.

A first embodiment:

In a specific embodiment of the disclosure, when intelligent shopping guide is carried out for a current customer, a customer category to which the current customer belongs needs to be firstly determined, wherein the customer categories are categories obtained by extracting customer characteristics each corresponding to each customer data from a plurality of customer data stored in advance and clustering the extracted customer characteristics.

Specifically, as shown in FIG. 2, the specific embodiment of the present disclosure takes the customer data for G customers stored in advance as an example. The customer characteristics of each customer are extracted from the stored customer data, wherein the customer characteristics include: gender; age; height; weight; measurements of chest, waist, and hips; personality; preference; historical purchase style and the like. And the customer characteristics are clustered using a clustering algorithm to obtain K customer categories, such as customer category K1, customer category K2 and the like, wherein each customer category represents a customer type, for example, the customer category K1 is for females aged between 20 and 35 years, weighing between 49 kg and 55 kg, and having a historical purchase style of mostly waisted dresses. In implementation, the specific embodiment of the disclosure can adopt a k-means clustering algorithm, input the number k of clusters and a database containing n data objects, and output k clusters meeting the minimum variance criterion.

Specifically, as shown in FIG. 2, when intelligent shopping guide is carried out for the current customer, the customer data of the current customer is acquired, and the customer data of the current customer includes gender; age; height; weight; measurements of chest, waist, and hips; personality; preference; historical purchase style and the like, and the customer characteristics are extracted from the customer data. For example, the extracted customer characteristics include gender, height, weight, historical purchase style and the like. The specific method for extracting the customer characteristics from the customer data is similar to the prior art and will not be repeated here.

Specifically, as shown in FIG. 2, according to the extracted customer characteristics and a plurality of preset customer categories, a customer category to which the current customer belongs is determined using a k-nearest neighbor algorithm. For example, according to the extracted customer characteristics (gender, height, weight, historical purchase style, etc.), and the preset customer category K1, customer category K2, etc., the customer category to which the current customer belongs is determined to be the customer category Kn using the k-nearest neighbor algorithm. The core idea of the k-nearest neighbor algorithm is that if most of the k nearest neighboring samples in a characteristic space where a sample is located belong to a certain category, then the sample also belongs to this category and has the characteristics of the samples in this category. In determining the classification decision, the k-nearest neighbor algorithm only determines the category to which the sample to be classified belongs according to the category of the nearest sample or samples.

Specifically, as shown in FIG. 2, the commodity of a specific embodiment of the present disclosure takes F sets of apparel stored in advance as an example. The commodity types are types obtained by extracting commodity characteristics corresponding to customer characteristics from a plurality of commodity data stored in advance and clustering the extracted commodity characteristics. During implementation, apparel characteristics corresponding to the customer characteristics can be extracted from the apparel data of each set of apparel, and the extracted apparel characteristics include: suitable age, suitable weight, size, apparel length, color, style and the like. For example, a currently stored red ladies' professional suit F2, its apparel characteristics represent that the apparel is suitable for women aged between 20 and 35, weighing between 49 kg and 52 kg, having calm personality, and the apparel is a two-piece dress in design and is decently styled, suitable for business, and the like. And the extracted apparel characteristics are clustered to obtain apparel types, such as apparel type F 1, apparel type F2 and the like. In practice, a specific embodiment of the present disclosure may employ a K-means clustering algorithm to cluster the extracted apparel characteristics.

According to an aspect of the present disclosure, an embodiment of the present disclosure may also similarly classify shop data, including conventional discount event information for the shop, and the like. Accordingly, when clustering the extracted customer characteristics, characteristics of the customer's sensitivity to preferred shops or events may also be included.

Specifically, as shown in FIG. 2, the commodity types (e.g., the apparel type F1, the apparel type F2, etc.) are matched with the customer categories (e.g., the customer category K1, the customer category K2, etc.) one by one. In implementation, the specific embodiment of the present disclosure uses a k-nearest neighbor algorithm to match the commodity types with the customer categories one by one, such as: classifying and matching the apparel types, respectively matching the apparel type Fi with the K customer categories and determining that the apparel type Fi is most suitable for the customer category Kf among the K customer categories. This matching is essentially mutual, with each customer category having a corresponding matching apparel type.

Specifically, as shown in FIG. 2, according to the matching result of the above apparel types and the customer categories, and according to the customer category to which the current customer belongs, the apparel type suitable for the current customer is derived using a mapping relationship, for example, a preferred apparel among the m apparel types suitable for the current customer may be derived using the mapping relationship, or the first m sets of apparel among the most matching apparel types may be derived using the mapping relationship.

Specifically, as shown in FIG. 2, the intelligent shopping guide method of the specific embodiment of the disclosure further comprises the following steps: acquiring an image data of a current customer, retrieving an image data of an apparel recommended to the current customer, synthesizing the image data of the current customer and the image data of the apparel by adopting an image processing method, and generating a try-on view of the current customer trying on the apparel so as to facilitate the customer to better select apparel suitable for the customer.

Specifically, the specific embodiment of the present disclosure further comprises forming a shopping route map to a shop location to which the commodity type suitable for the current customer belongs after determining the commodity type suitable for the current customer and providing the shopping route map to the current customer, so that the customer can select the commodity suitable for himself or herself more conveniently.

Specifically, the intelligent shopping guide method provided by the specific embodiment of the disclosure further comprises the following steps: establishing a guide language matching model according to historical customer characteristic or current customer characteristic, so that better guiding opinions can be provided to the customer, and the customer can select the commodity which the customer likes in a targeted manner.

### A Second Embodiment

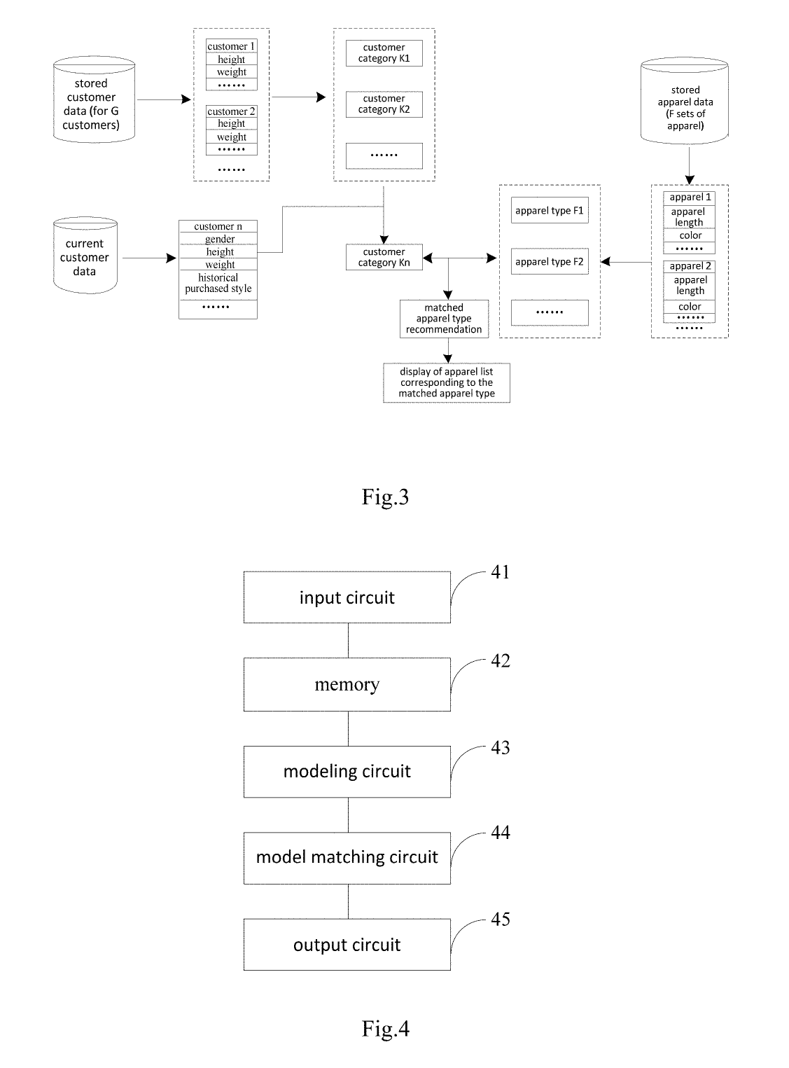

As shown in FIG. 3, the second embodiment of the present disclosure is different from the first embodiment of the present disclosure in that the second embodiment does not match the apparel types and the customer categories one by one after generating the apparel types and the customer categories, but uses a k-nearest neighbor algorithm to match the customer category to which the current customer belongs with the apparel types to determine a apparel type suitable for the current customer. For example, a k-nearest neighbor algorithm may be used to obtain a preferred apparel among m apparel types suitable for the current customer, or a k-nearest neighbor algorithm may be used to obtain the first m sets of apparel among the most matched apparel types.

Specifically, the specific embodiment of the present disclosure further comprises forming a shopping route map to a shop location to which the commodity type suitable for the current customer belongs after determining the commodity type suitable for the current customer and providing the shopping route map to the current customer, so that the customer can select the commodity suitable for herself or himself more conveniently.

Specifically, the intelligent shopping guide method provided by the specific embodiment of the disclosure further comprises the following steps: establishing a guide language matching model according to the historical customer characteristic or the current customer characteristic, so that better guiding opinions can be provided to the customer, and the customer can select the commodity which the customer likes in a targeted manner.

The intelligent shopping guide device provided by a specific embodiment of the present disclosure is described in detail below with reference to the accompany drawings.

Base on the same inventive concept, as shown in FIG. 4, an embodiment of the present disclosure also provides an intelligent shopping guide device, which comprise:

an input circuit 41 for acquiring customer data of a current customer;

a memory 42 for storing a plurality of customer data in advance and storing a plurality of commodity data in advance;

a modeling circuit 43 for extracting customer characteristics corresponding to each customer data from a plurality of customer data stored in the memory, and clustering the extracted customer characteristics to obtain a plurality of customer categories; and extracting commodity characteristics corresponding to the customer characteristics from a plurality of commodity data stored in the memory, and clustering the extracted commodity characteristics to obtain a plurality of commodity types;

a model matching circuit 44 for extracting customer characteristics from the customer data, and determining a customer category to which the current customer belongs according to the extracted customer characteristics and the customer categories obtained by the modeling circuit; and determining a commodity type suitable for the current customer according to the customer category to which the current customer belongs and the commodity types obtained by the modeling circuit;

an output circuit 45 for recommending a commodity corresponding to the commodity type suitable for the current customer determined by the model matching circuit to the current customer.

In one specific embodiment, the model matching circuit 44 is specifically configured to use a k-nearest neighbor algorithm to match the commodity types with the customer categories one by one and derive a commodity type suitable for the current customer based on the matching result and the customer category to which the current customer belongs.

In another specific embodiment, the model matching circuit 44 is specifically configured to use a k-nearest neighbor algorithm to match the customer category to which the current customer belongs with the commodity type to determine a commodity type suitable for the current customer.

Specifically, the model matching circuit 44 in a specific embodiment of the present disclosure is specifically configured to determine the customer category to which the current customer belongs using a k-nearest neighbor algorithm based on the extracted customer characteristics and the customer categories obtained by the modeling circuit 43.

Specifically, when the commodity type in the specific embodiment of the present disclosure is the apparel type, the input circuit 41 in the specific embodiment of the present disclosure is further configured to acquire an image data of the current customer. The model matching circuit 44 in the specific embodiment of the present disclosure is further configured to retrieve an image data of an apparel recommended to the current customer, synthesize the image data of the current customer and the image data of the apparel by adopting an image processing method, and generate a try-on view of the current customer trying on the apparel. The output circuit 45 is further configured to provide a try-on view of the current customer trying on the apparel to the current customer.

Specifically, the modeling circuit 43 in a specific embodiment of the present disclosure is also used to establish a guide language matching model. In implementation, the memory 42 in the specific embodiment of the present disclosure is also used to store a guide language library in advance that includes a large amount of languages that provide guidance to customers. The modeling circuit 43 establishes different guide language matching models according to the guide language library stored in the memory 42 in advance and according to the historical customer characteristics (e.g., age, personality and emotion analysis, etc.) or the current customer characteristics, so that the customer can select the commodity she or he likes in a more targeted way.

Specifically, the model matching circuit 44 in the specific embodiment of the present disclosure is further configured to form a shopping route map to a shop location to which the commodity type suitable for the current customer belongs after the commodity type suitable for the current customer is determined. The output circuit 45 in that specific embodiment of the present disclosure is also configured to provide the resulting shopping route map to the current customer.

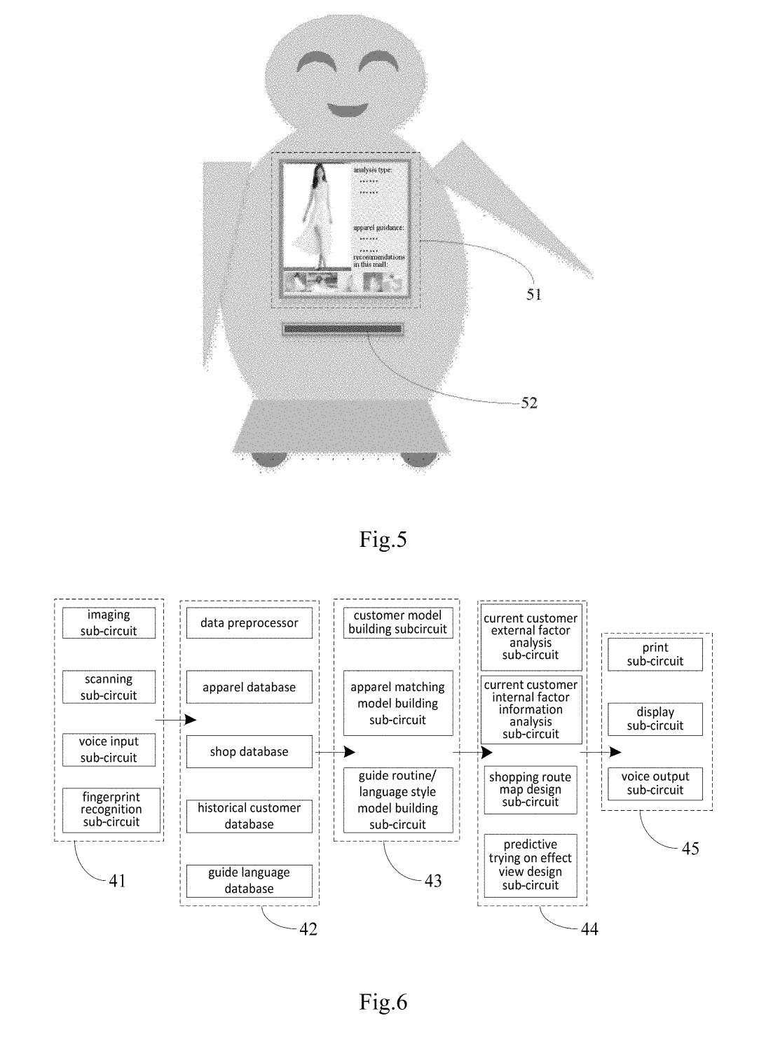

Specifically, as shown in FIG. 5, the intelligent shopping guide device provided by the specific embodiment of the present disclosure further comprises an output circuit 45 for printing the shopping route map and printing the try-on view of the current customer trying on the apparel. In implementation, the output circuit 45 in the specific embodiment of the present disclosure may comprise a print sub-circuit 52, a display sub-circuit and the like, and the print sub-circuit 52 is configured to print the shopping route map and print the try-on view of the current customer trying on the apparel. The display sub-circuit comprises, for example, a display screen 51.

As shown in FIG. 5, the display screen 51 may be a partitioned display screen, e.g., the display screen 51 may be divided into three regions. The first region is used to display the try-on view of a customer trying on an apparel; the second region is used to display preferred apparel pictures of other shops in the shopping mall; and the third region is used to present the results of data modeling and model matching of the software system through simplified language, providing professional basis for customers. Of course, in practical application, the display screen 51 in the specific embodiment of the present disclosure may also be a full-screen display, such as full-screen displaying the shopping route map.

In implementation, as shown in FIG. 6, the input circuit 41 in the specific embodiment of the present disclosure includes at least one of an imaging sub-circuit, a scanning sub-circuit, a voice input sub-circuit, and a fingerprint recognition sub-circuit. The memory 42 includes a data preprocessor, an apparel database, a shop database, a historical customer database, and a guide language database. The modeling circuit 43 includes a customer model building sub-circuit, an apparel matching model building sub-circuit, and a guide routine/language style model building sub-circuit. The model matching circuit 44 includes a current customer external factor analysis sub-circuit, a current customer internal factor information analysis sub-circuit, a shopping route map design sub-circuit, and a predictive trying on effect view design sub-circuit of an apparel. The output circuit 45 includes a print sub-circuit, a display sub-circuit and a voice output sub-circuit.

In specific implementation, as shown in FIG. 6, the data preprocessor is used for converting the original data into structured data, wherein the apparel database comprises category, price, number, size, color, style and the like of the apparel, the shop database comprises the booth number, event information and the like of the shop, and the historical customer database comprises age, skin color, body shape, purchasing power, preference, successful purchase/failure promotion records and the like of the customer. The customer model can be divided into different types of models according to age, body shape, face shape, skin color, personality, current emotional state, etc., wherein the model to which the historical customer belongs can be adjusted. The apparel matching model building can classify apparels based on different dimensions, establish apparel matching models corresponding to different customer models according to customer preferences. The apparel matching model building and the guiding routine/language style model building can establish different guiding language matching models according to historical/current customer age, personality and emotion analysis. The external factor analysis of a current customer includes: whether the customer is a historical customer or not; current clothing style attribution; age; face shape; skin color type, etc. Current customer internal factor information analysis includes: mental state, emotional state, personality type, style preference predication, etc.

In another specific embodiment, the intelligent shopping guide device comprises a processor and a memory storing computer program instructions. The processor is configured to execute the computer program instructions stored on the memory to perform the steps of:

acquiring customer data of a current customer, extracting customer characteristics from the customer data, and determining a customer category to which the current customer belongs according to the extracted customer characteristics and a plurality of preset customer categories;

according to the customer category to which the current customer belongs and a plurality of preset commodity types, determining a commodity type suitable for the current customer, and

recommending a commodity corresponding to the commodity type suitable for the current customer to the current customer.

In addition, it should be understood that the intelligent shopping guide device according to this embodiment may also include other elements or components in the intelligent shopping guide device described in detail above in connection with the accompanying drawings. Furthermore, the processor is also capable of performing other steps in the intelligent shopping guide method described particularly in first embodiment or the second embodiment above.

In yet another embodiment, the intelligent shopping guide device comprises:

an input circuit for acquiring customer data of a current customer;

a memory storied computer program instructions, a plurality of customer data and a plurality of commodity data;

a processor which is configured to execute the computer program instruction stored on the memory to perform the following steps:

extract customer characteristics each corresponding to each customer data from a plurality of customer data stored in the memory, and cluster the extracted customer characteristics to obtain a plurality of customer categories;

extract commodity characteristics corresponding to the customer characteristics from a plurality of commodity data stored in the memory, and cluster the extracted commodity characteristics to obtain a plurality of commodity types;

extract customer characteristics from the customer data, and determine a customer category to which a current customer belongs according to the extracted customer characteristics and the customer category obtained by the modeling circuit; and

determine a commodity type suitable for the current customer according to the customer category to which the current customer belongs and the commodity type obtained by the modeling circuit;

an output circuit for recommending a commodity corresponding to the determined commodity type suitable for the current customer to the current customer.

In addition, it should be understood that the intelligent shopping guide device according to this embodiment may also include other elements or components in the intelligent shopping guide device described in detail above in connection with the accompanying drawings. Furthermore, the processor is also capable of performing other steps in the intelligent shopping guide method described particularly in the first embodiment or the second embodiment above.

The intelligent shopping guide device provided by the specific embodiment of the present disclosure has the following advantages in addition to the basic structure and functions of the device in the related art:

firstly, it can classify, model and analyze the stored customer data and the current customer data to establish a customer category data model; secondly, it can classify, model and analyze the stored apparel data and shop data, and establish apparel data models with different styles and positioning; and thirdly, it can classify and analyze the stored history purchase/promotion success/failure records, match and analyze the customer categories and the apparel types according to the classification and analysis, generate an optimized apparel recommendation scheme and a guide scheme for different customer categories, and generate a try-on effect view and a shopping route map according to the recommendation scheme and the guide scheme for printing and viewing.

In summary, the intelligent shopping guide method and the intelligent shopping guide device provided by the specific embodiment of the present disclosure can acquire customer data of a current customer, extract customer characteristics from the customer data, and determine a customer category to which the current customer belongs according to the extracted customer characteristics and a plurality of preset customer categories; according to the customer category to which the current customer belongs and a plurality of preset commodity types, determine a commodity type suitable for the current customer, and recommend a commodity corresponding to the commodity type suitable for the current customer to the current customer. Therefore, the intelligent shopping guide method and the intelligent shopping guide device provided by the specific embodiment of the present disclosure can provide more intelligent and personalized purchase suggestions for customers.

It will be apparent to those skilled in the art that various changes and modifications may be made to the present disclosure without departing from the spirit and scope of the disclosure. Thus, it is intended that the present disclosure also encompass such modifications and variations as fall within the scope of the appended claims and their equivalents.

1. An intelligent shopping guide method, comprising following steps:
acquiring customer data of a current customer, extracting customer characteristics from the customer data, and determining a customer category to which the current customer belongs according to the extracted customer characteristics and a plurality of preset customer categories;
determining a commodity type suitable for the current customer according to the customer category to which the current customer belongs and a plurality of preset commodity types, and
recommending a commodity corresponding to the commodity type suitable for the current customer to the current customer.

2. The intelligent shopping guide method according to claim 1, wherein determining the commodity type suitable for the current customer according to the customer category to which the current customer belongs and the plurality of preset commodity types comprises:
matching the commodity types with the customer categories one by one, and deriving the commodity corresponding to the commodity type suitable for the current customer according to the matching result and the customer category to which the current customer belongs.

3. The intelligent shopping guide method according to claim 2, wherein matching the commodity types with the customer categories one by one comprises:
matching the commodity types with the customer categories one by one using a k-nearest neighbor algorithm.

4. The intelligent shopping guide method according to claim 1, wherein determining the commodity type suitable for the current customer according to the customer category to which the current customer belongs and the plurality of preset commodity types comprises:
matching the customer category to which the current customer belongs with the commodity types using a k-nearest neighbor algorithm and determining the commodity type suitable for the current customer.

5. The intelligent shopping guide method according to claim 1, wherein when the commodity type is an apparel type, the method further comprises: acquiring an image data of the current customer and retrieving an image data of an apparel recommended to the current customer, synthesizing the image data of the current customer and the image data of the apparel by adopting an image processing method, and generating a try-on view of the current customer trying on the apparel.

6. The intelligent shopping guide method according to claim 1, wherein determining the customer category to which the current customer belongs according to the extracted customer characteristics and the plurality of preset customer categories comprises:
determining the customer category to which the current customer belongs using a k-nearest neighbor algorithm according to the extracted customer characteristics and the plurality of preset customer categories.

7. The intelligent shopping guide method according to claim 1, wherein after determining the commodity type suitable for the current customer, the method further comprises: forming a shopping route map to a shop location to which the commodity type suitable for the current customer belongs and providing the shopping route map to the current customer.

8. An intelligent shopping guide device, wherein the intelligent shopping guide device comprises:
an input circuit for acquiring customer data of a current customer;
a memory for storing a plurality of customer data in advance and storing a plurality of commodity data in advance;
a modeling circuit configured to: extract customer characteristics each corresponding to each customer data from the plurality of customer data stored in the memory, and cluster the extracted customer characteristics to obtain a plurality of customer categories; and extract commodity characteristics corresponding to the customer characteristics from the plurality of commodity data stored in the memory, and cluster the extracted commodity characteristics to obtain a plurality of commodity types;
a model matching circuit configured to extract customer characteristics from the customer data, and determine a customer category to which the current customer belongs according to the extracted customer characteristics and the customer categories obtained by the modeling circuit; and determine a commodity type suitable for the current customer according to the customer category to which the current customer belongs and the commodity types obtained by the modeling circuit;
an output circuit for recommending a commodity corresponding to the commodity type suitable for the current customer determined by the model matching circuit to the current customer.

9. The intelligent shopping guide device according to claim 8, wherein the model matching circuit is configured to match the commodity types with the customer categories one by one using a k-nearest neighbor algorithm and derive the commodity type suitable for the current customer according to the matching result and the customer category to which the current customer belongs.

10. The intelligent shopping guide device according to claim 8, wherein the model matching circuit is configured to match the customer category to which the current customer belongs with the commodity types using a k-nearest neighbor algorithm and determine the commodity type suitable for the current customer.

11. The intelligent shopping guide device according to claim 8, wherein when the commodity type is an apparel type:
the input circuit is further configured to acquire an image data of the current customer;
the model matching circuit is further configured to: retrieve an image data of an apparel recommended to the current customer, synthesize the image data of the current customer and the image data of the apparel using an image processing method, and generate a try-on view of the current customer trying on the apparel;
the output circuit is further configured to provide the try-on view of the current customer trying on the apparel to the current customer.

12. The intelligent shopping guide device according to claim 8, wherein the model matching circuit is configured to determine the customer category to which the current customer belongs using a k-nearest neighbor algorithm based on the extracted customer characteristics and the customer categories obtained by the modeling circuit.

13. The intelligent shopping guide device according to claim 8, wherein the model matching circuit is further configured to: form a shopping route map to a shop location to which the commodity type suitable for the current customer belongs after the commodity type suitable for the current customer is determined;
the output circuit is further configured to provide the shopping route map to the current customer.

14. The intelligent shopping guide device according to claim 8, wherein the output circuit is further configured to print the shopping route map and the try-on view of the current customer trying on the apparel.
